(19) United States
(12) Patent Application Publication
(10) Pub. No.: US 2019/0174922 A1
(43) Pub. Date: Jun. 13, 2019

(54) CONVEYANCE SEAT

(71) Applicant: TS TECH CO., LTD., Asaka-shi, Saitama (JP)

(72) Inventors: Koji Onuma, Tochigi (JP); Kazuki Kobayashi, Tochigi (JP)

(21) Appl. No.: 16/323,903

(22) PCT Filed: Mar. 31, 2017
(86) PCT No.: PCT/JP2017/013790

§ 371 Date: Feb. 7, 2019

(30) Foreign Application Priority Data
Aug. 9, 2016 (JP) 2016-156886

(51) Int. Cl. A47C 7/02; A47C 7/74; B60N 2/68

(52) U.S. Cl. CPC A47C 7/02; B60N 2/68; A47C 7/74

(57) ABSTRACT

Provided is a conveyance seat including a pan frame suitable for attaching a member inside the seat. The vehicle seat includes a cushion frame which includes side frames respectively disposed at the right and left sides, a front connection pipe connecting the right and left side frames, and a pan frame attached to front ends of the side frames. The pan frame includes an inclined portion which is provided at a rear end side of a center side in a seat width direction to be inclined downward as it extends backward and a lower end portion of the inclined portion is located below an upper end of the front connection pipe.

### CROSS-REFERENCE TO RELATED APPLICATIONS

This application is a National Stage Entry application of PCT Application No. PCT/JP2017/013790, filed Mar. 31, 2017, which claims the priority benefit of Japanese Patent Application No. JP 2016-156886, filed on Aug. 9, 2016, the contents of each of which being incorporated herein by reference.

### BACKGROUND

The present disclosure relates to a conveyance seat and particularly to a conveyance seat including a pan frame suitable for attaching a member inside the seat.

Electric devices such as an air conditioning device for cooling a vehicle seat by a fan, a motor for sliding the seat, and a control device for controlling these components are disposed inside the vehicle seat and a linear member such as a wire harness for connecting these components is stretched therein.

For example, Japanese Patent Publication JP 2015-67151 discloses a configuration in which a ventilator corresponding to an air conditioning device is provided below a cushion frame constituting a conveyance seat. Then, JP 2015-67151 discloses a configuration which does not disturb springiness of a support spring cross-linked to the cushion frame when the ventilator is provided below the cushion frame.

When various electric devices are disposed inside the conveyance seat and a linear member such as a wire harness connecting these members is provided inside the conveyance seat, an arrangement interference between the members inside the seat tends to occur. In this case, there is a possibility that the members inside the seat are disposed while being bent too much.

Further, in a state in which a vibration is repeatedly applied to the vehicle due to shaking when the vehicle travels, there is a possibility that the linear member inside the seat is bent since the arrangement of respective members inside the conveyance seat is more or less shifted although the linear member is not bent at the beginning of product shipment. In this way, since there is a possibility that the linear member is disconnected when a load is repeatedly applied thereto in a state in which the linear member inside the seat is bent, it was difficult to stably use various electric devices provided in the conveyance seat for a long time.

In the conveyance seat disclosed in JP 2015-67151, the arrangement interference between the ventilator and the support spring can be prevented, but since a member associated with the linear member is not taken into consideration, there is a possibility that an arrangement interference may occur between the member involving with the linear member and the other members.

### SUMMARY

The present disclosure has been made in view of the above-described problems and an embodiment of the present disclosure provides a conveyance seat including a pan frame suitable for attaching a member inside the seat. Further, another embodiment of the present disclosure prevents a linear member inside the seat from being disconnected.

The above-described problems are solved by a conveyance seat according to an embodiment of a conveyance seat that includes: a cushion frame which includes right and left side frames respectively disposed at right and left sides of the cushion frame, a connection member that connects the right and left side frames, and a pan frame attached to respective front ends of the right and left side frames, in which the pan frame includes an inclined portion which is provided at a rear end side of a center side in a seat width direction and is inclined downward as it extends backward, and in which a lower end portion of the inclined portion is located below an upper end of the connection member. According to the above-described configuration, the lower end portion of the inclined portion provided at the rear end side of the center side of the pan frame in the seat width direction is formed to be located below the upper end of the connection member. For this reason, the member inside the seat is more easily attached to the inclined portion of the pan frame while passing below the connection member when the member inside the seat is attached along the pan frame.

Further, the lower end portion of the inclined portion may be located below a center axis of the connection member. According to the above-described configuration, since the lower end portion of the inclined portion is located below the center axis of the connection member, the member inside the seat can be easily attached to the inclined portion of the pan frame while passing below the connection member when the member inside the seat is attached along the pan frame.

Further, the inclined portion may be provided with an attachment portion to which a linear member is attached. According to the above-described configuration, since the inclined portion is provided with the attachment portion to which the linear member is attached, the linear member can be easily attached along the inclined portion. Further, since it is possible to prevent the linear member from being bent too much in the up to down direction, the disconnection thereof can be prevented.

Further, the pan frame may be provided with a concave portion having an inverse U-shaped cross-section that extends in a right to left direction. According to the above-described configuration, since the concave portion having an inverse U-shaped cross-section and extending in the right to left direction is formed in the pan frame, the concave portion can be used as a space for accommodating the linear member. As a result, it is possible to prevent a contact with other harnesses and ECUs.

Further, a bead having an inverse U-shaped cross-section may be formed along an edge of the concave portion. According to the above-described configuration, since the pan frame is provided with the bead having an inverse U-shaped cross-section, it is possible to improve the rigidity of the pan frame.

Further, an extension portion which extends in the front to back direction of the seat may be formed at right and left sides of the pan frame and the extension portion may be located above the connection member and extend towards the rear side of the pan frame. According to the above-described configuration, since the extension portion is located above the connection member and extends to the rear side, it is possible to prevent the linear member from being bent upward when one linear member is attached along the side frames at both sides of the pan frame while passing between the connection member and the extension portion.

Further, the extension portion may be provided with a side bead and the side bead may extend toward a center of the extension portion from an outside of the seat width direction in relation to a connection portion between the side frame and the pan frame. According to the above-described configuration, since the extension portion is provided with the side bead which extends from the outside in the seat width direction to the center, it is possible to improve the rigidity of the extension portion.

Further, both ends of the inclined portion may be connected to an outer portion of the pan frame in the seat width direction at an upright wall having a polygonal shape in side view. According to the above-described configuration, since the pan frame includes the inclined portion and the upright wall, the linear member can be easily attached while passing below the outer end side in the seat width direction in relation to the upright wall. Further, since the inclined portion and the outer portion in the seat width direction are connected by the upright wall having a polygonal shape in side view, it is possible to improve the rigidity of the inclined portion.

According to an embodiment, it is possible to provide a conveyance seat including a pan frame suitable for attaching a member inside a seat. Further, according to an embodiment, it is possible to easily attach a linear member inside the seat to the pan frame. It is possible to prevent the disconnection of the linear member. Further, according to an embodiment, it is possible to provide a space for accommodating the linear member in the pan frame. Further, according to an embodiment, it is possible to improve the rigidity of the pan frame.

### BRIEF DESCRIPTION OF DRAWINGS

FIG. 1 is a perspective view showing a vehicle seat according to an embodiment.

FIG. 2 is a perspective view showing a seat frame.

FIG. 3 is a plan view showing a pan frame.

FIG. 4 is a schematic cross-sectional view showing a pan frame to which a wire harness or the like is attached at a position corresponding to a position of a cross-section IV-IV of FIG. 3.

### DETAILED DESCRIPTION

Hereinafter, an embodiment (the present embodiment) of the present disclosure is described with reference to the drawings. Furthermore, the embodiments described below are merely examples for facilitating the comprehension of the present disclosure and do not limit the present disclosure. That is, the embodiments can be modified and improved without departing from the spirit thereof and the equivalents thereof are, of course, included in the present disclosure.

Hereinafter, a vehicle seat is described as a conveyance seat according to the present embodiment. The invention can also be applied to vehicles other than automobiles and can also be applied to, for example, ships, aircraft, industrial machines, and the like.

Furthermore, in the description below, the “right to left” means the right to left direction when an occupant sitting on the conveyance seat faces forward and the right to left direction (the right to left direction of the seat) is also referred to as the seat width direction. Further, the “front to back direction” means the front to back direction when the occupant sits on the conveyance seat.

Vehicle Seat S and Seat Frame Sa

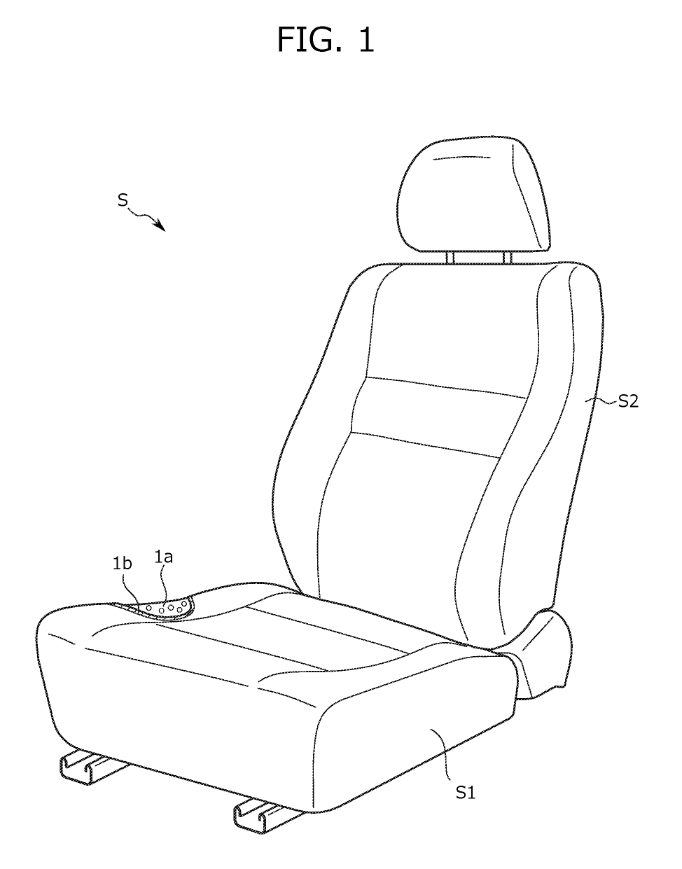

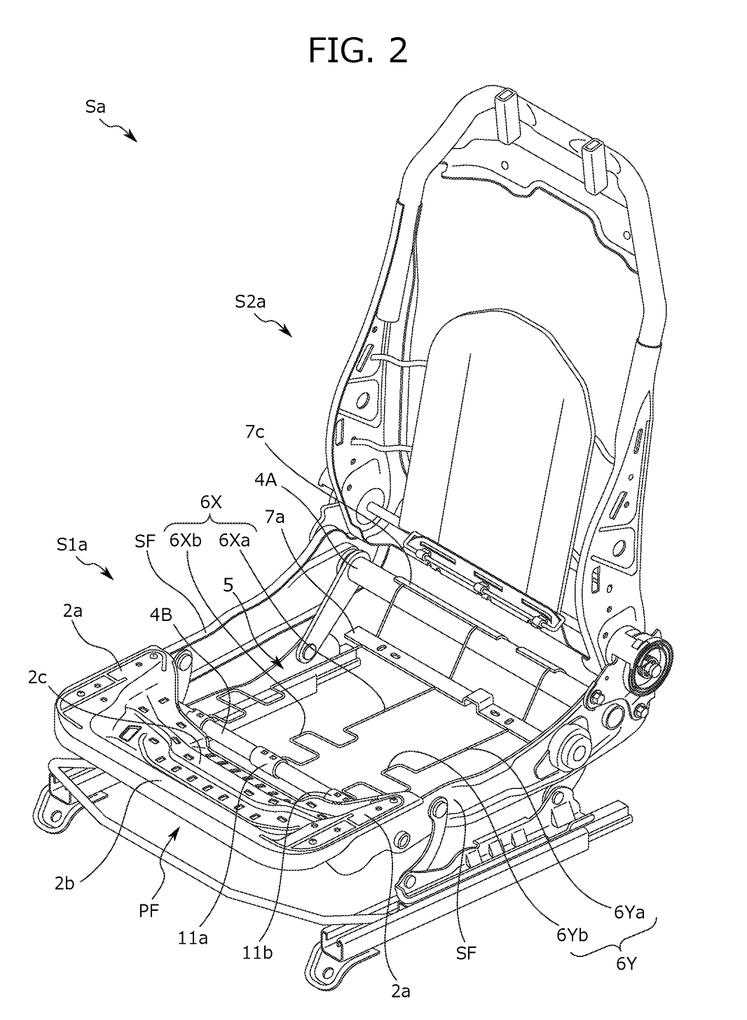

First, a vehicle seat S and a seat frame Sa according to the present embodiment is described with reference to FIGS. 1 and 2. Furthermore, FIG. 1 is a perspective view showing the vehicle seat S according to the present embodiment and FIG. 2 is a perspective view showing the seat frame Sa. The vehicle seat S mainly includes a seat cushion S1 which is a seating portion and a seat back S2 which is a backrest.

The seat cushion S1 includes a cushion frame S1a shown in FIG. 2, a cushion pad 1a placed on the cushion frame S1a, and a skin 1b covering the cushion pad 1a and fixed to the cushion frame S1a. The seat back S2 includes a back frame S2a attached to a rear end portion of the seat cushion S1 and shown in FIG. 2. Then, the seat frame Sa is constituted by the cushion frame S1a and the back frame S2a.

The cushion frame S1a mainly includes side frames SF which are side frames provided at the right and left sides and extending in the front to back direction, a rear connection pipe 4A which connects rear ends of the right and left side frames SF, a front connection pipe 4B which is a connection member connecting front ends thereof, and a pan frame PF which is attached to upper portions of the front ends of the right and left side frames SF. Attachment members 11a and 11b at the front end side of the cushion member 5 for giving a cushioning property to the seat cushion S1 are attached to the front connection pipe 4B.

Cushion Member 5

The cushion member 5 mainly includes a locking plate 7c which is locked to the rear connection pipe 4A, three wires 6X and 6Y which extend in the front to back direction of the seat while the rear ends are enclosed in the locking plate 7c, a plate-shaped horizontal extension plate 7a which is disposed below the locking plate 7c, connects the rear ends of the wires 6X and 6Y in an enclosed state, and is substantially horizontally disposed to extend in the right to left direction, and the attachment members 11a and 11b which are attached to the front connection pipe 4B while enclosing the front ends of the wires 6X and 6Y.

Further, in the present embodiment, among three wires 6X and 6Y, two right wires 6X are formed in the same shape and one left wire 6Y is formed in a shape symmetrical with the shapes of two right wires. Furthermore, the number of the wires 6X and 6Y can be set arbitrarily. In particular, the wires 6X and 6Y mainly include straight portions 6Xa and 6Ya which are rear portions protruding forward from the horizontal extension plate 7a and S-shaped portions 6Xb and 6Yb of which bent portions are continuously formed in an S shape in an overlapping state.

Further, the shapes of the plurality of wires 6X and 6Y are preferably symmetrical in that the right and left elasticity are equalized. However, in the case of an odd number as in the present embodiment, it is preferable that the center wire 6X have the same shape as those of the right and left wires 6X and 6Y. This is because the center wire 6X has a less influence of equivalent elasticity in the right to left direction as compared with the wires 6X and 6Y located at the right and left end portions.

### Pan Frame PF

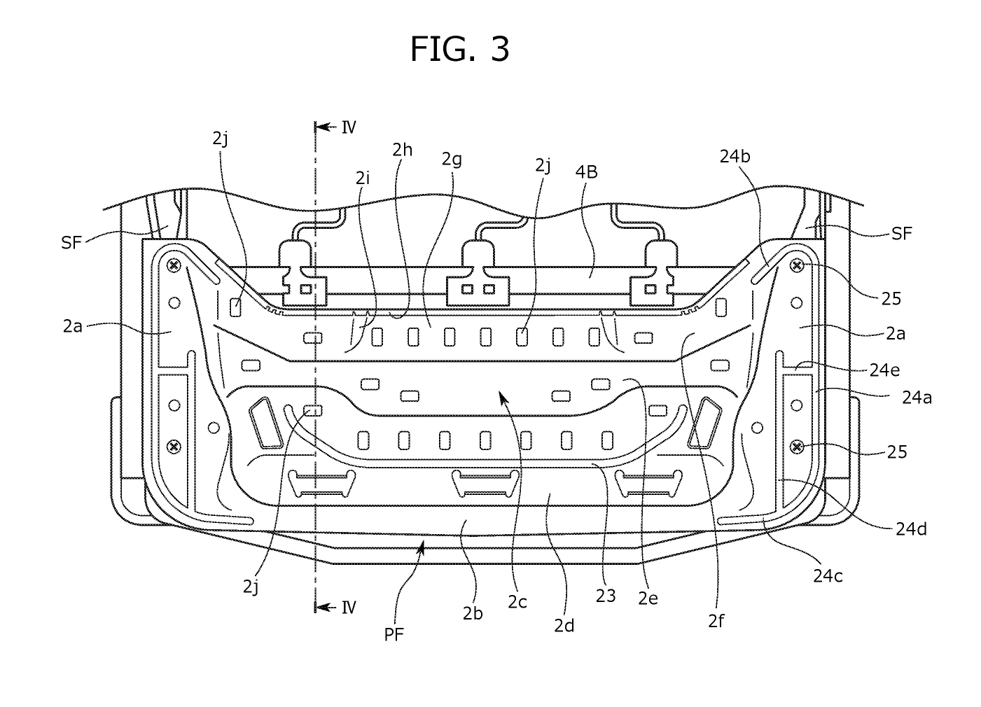

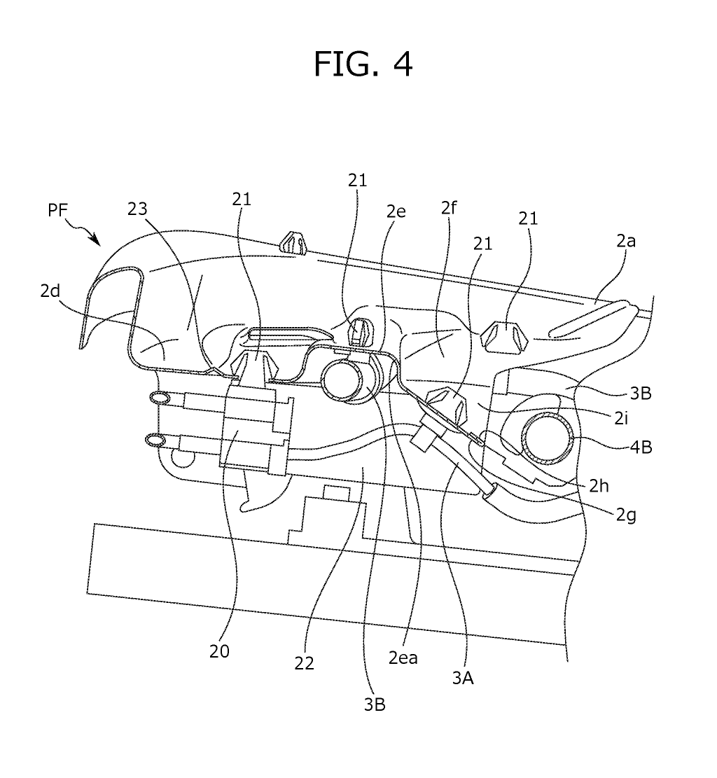

Next, the pan frame PF is described with reference to FIGS. 3 and 4 in addition to FIG. 2. Furthermore, FIG. 3 is a plan view showing the pan frame PF and is a schematic cross-sectional view showing the pan frame PF to which wire harnesses 3A and 3B or the like are attached at a position corresponding to a position of a cross-section IV-IV of FIG. 3.

The pan frame PF is used to support thighs of a seated occupant and is formed by a metallic plate member that is long in the seat width direction and is short in the front to back direction of the seat as shown in FIGS. 2 and 3. A center side of the pan frame PF is located at a front side in relation to the front connection pipe 4B. Specifically, the pan frame PF includes a side extension portion 2a which is an extension portion located at each of both end portions in the right to left direction of the seat and extending in the front to back direction of the seat, a front extension portion 2b which is formed to be continuous to the front end portion of the side extension portion 2a and extends in the seat width direction, and a center portion 2c which is provided between the side extension portion 2a and the front extension portion 2b.

The pan frame PF is connected to the upper surface of the side frame SF while a fastener (e.g., screw) 25 corresponding to a connection portion passes through the front and rear ends of the side extension portion 2a, located at both end portions in the seat width direction, in the thickness direction. Further, the side extension portion 2a is located above the front connection pipe 4B and the rear end of the side extension portion 2a extends to the rear side in relation to the front connection pipe 4B.

Further, symmetrical side beads 24 are formed at the side extension portions 2a at both end portions in the seat width direction. The side bead 24 is used to improve the rigidity of the side extension portion 2a, is formed in a linear shape in plan view, and is formed while being bent in an inverse U-shaped cross-section to protrude upward in relation to the peripheral portion. In particular, the side bead 24 includes an outer extension portion 24a which is located at the outside in the seat width direction, a rear side extension portion 24b, a front side extension portion 24c, an inner extension portion 24d which is located at the inside in the seat width direction, and a joint portion 24e which joins the outer extension portion 24a and the inner extension portion 24d to each other.

The outer extension portion 24a extends in the front to back direction while being located at the outer end side in the seat width direction in relation to the fastener 25. The rear side extension portion 24b is located at the rear end side of the side extension portion 2a and is formed to extend obliquely forward at the inside of the seat width direction from the rear side of the fastener 25 at the rear end side. Similarly, the front side extension portion 24c is located at the front end side of the side extension portion 2a and is formed to pass through the front side of the fastener 25 at the front end side and to extend to the center side beyond the fastener 25 from the outside in the seat width direction in relation to the fastener 25. The inner extension portion 24d is formed at the inside in the seat width direction to be parallel to the outer extension portion 24a with the fastener 25 interposed therebetween and extends from the front side extension portion 24c in the front to back direction to be shorter than the outer extension portion 24a. The joint portion 24e is located at a position between the front and rear fasteners 25 and extends in a direction perpendicular to the extension direction of the outer extension portion 24a and the inner extension portion 24d so that the outer extension portion and the inner extension portion are connected at a position slightly in front of the rear end of the inner extension portion 24d.

The front extension portion 2b forms the front end of the pan frame PF and is formed to be continuous to the front end side of the side extension portions 2a located at both ends in the seat width direction so that both portions are connected to each other.

The center portion 2c includes a front portion 2d, a bent protrusion portion 2e which is bent to protrude upward from the front portion 2d, a side portion 2f which is continuous to the rear end of the bent protrusion portion 2e, and an inclined portion 2g which is inclined with respect to the side portion 2f in order from the front side to the rear side.

The front portion 2d is formed to be located at a position lower than the front extension portion 2b in a state in which the pan frame PF is attached to the side frame SF. Then, in the front portion 2d, the bead 23 is formed along the front edge of the bent protrusion portion 2e, in other words, the front edge of the concave portion 2ea. The bead 23 is used to improve the rigidity of the front portion 2d of which the rigidity is low due to a plurality of attachment holes 2j formed therein and is bent in an inverse U-shaped cross-section to protrude upward in relation to the peripheral portion similarly to the side bead 24.

As described above, the bent protrusion portion 2e is bent from the front portion 2d to protrude upward and extends in the right to left direction of the seat. Specifically, the center portion of the bent protrusion portion 2e is formed to be long in the front to back direction, both end portions of the bent protrusion portion 2e in the seat width direction are formed to be short in the front to back direction, and the rear edge of the bent protrusion portion 2e is formed in a substantially crank shape in plan view. Then, since the bent protrusion portion 2e is formed to have substantially the same thickness as that of the front portion 2d, the rear surface of the bent protrusion portion 2e is provided with a concave portion 2ea which is recessed upward in relation to the front portion 2d and has an inverse U-shaped cross-section. The concave portion 2ea accommodates the wire harness 3B to be described below. The side portion 2f is formed to be continuous to the front side of the bent protrusion portion 2e and is formed to be continuous to the side extension portion 2a at both sides interposing the inclined portion 2g in the seat width direction.

The inclined portion 2g is formed to be continuous to the front side of the bent protrusion portion 2e and is formed at the center side in the seat width direction to be inclined obliquely backward with respect to the upper surfaces of the side portion 2f and the bent protrusion portion 2e located at both sides in the seat width direction. In other words, the inclined portion is inclined downward as it extends backward. The lower end of the inclined portion 2g is disposed below the upper end of the front connection pipe 4B. More specifically, the lower end is disposed at a position below the center axis of the front connection pipe 4B and above the lower end of the front connection pipe 4B.

Further, both ends of the inclined portion 2g are continuously connected to the side portions 2f through the upright wall 2i inclined obliquely upward as it goes outward in the seat width direction. The upright wall 2i is formed in a substantially right triangle shape in side view. In this way, since the pan frame PF includes the upright wall 2i and the inclined portion 2g is connected to the upright wall 2i, the wire harness 3B to be described below can be easily attached while passing below the side portion 2f located at the outer end side in the seat width direction in relation to the upright wall 2i. Further, since the inclined portion 2g and the side portion 2f are connected to each other by the upright wall 2i having a right triangle shape in side view, it is possible to improve the rigidity of the inclined portion 2g. Furthermore, in the present embodiment, the upright wall 2i is formed in a right triangle shape in side view, but may be formed in other triangle shapes or polygonal shapes such as a parallelogram shape and a trapezoidal shape as long as the upright wall is formed in a shape in which the side portion 2f and the inclined portion 2g of different inclination angles can be connected to each other in the front to back direction. In this way, since the side portion 2f and the inclined portion 2g are connected by the upright wall 2i having a polygonal shape in side view, it is possible to improve the rigidity of the inclined portion 2g.

The rear edges of the inclined portion 2g and the side portion 2f constituting the pan frame PF are folded back from the lower side to the upper side and from the upper side to the front side so that a hemming portion 2h is formed. Since the hemming portion 2h is formed in this way, it is possible to prevent the damage of the wire harnesses 3A and 3B corresponding to the linear members to be described below when the wire harnesses contact the hemming portion by rounding the rear edge.

Then, the front portion 2d, the bent protrusion portion 2e, and the inclined portion 2g are provided with the plurality of attachment holes 2j formed in a rectangular shape and used to attach clips 21 holding the wire harnesses 3A and 3B to be described below. The clips 21 serve as attachment portions for holding and attaching the wire harnesses 3A and 3B. When the clips 21 are attached to the attachment holes 2j, the wire harnesses 3A and 3B can be easily attached along the inclined portion 2g.

Pan Frame PF and Wire Harnesses 3A and 3B

The vehicle seat S according to the present embodiment includes a motor (not shown) which operates the seat forward and backward, an ECU 22 which controls the driving of the motor, and the wire harnesses 3A and 3B which electrically connect the motor and the ECU 22, and the like.

As shown in FIG. 4, the wire harness 3A is attached to the connector 20, passes below the front connection pipe 4B, and is supported by the clip 21 attached to the attachment hole 2j of the inclined portion 2g. As described above, the lower end of the inclined portion 2g is formed to be located below the upper end of the front connection pipe 4B. Since the inclined portion 2g is formed in this way, the wire harness 3A passing below the front connection pipe 4B is easily attached along the inclined portion 2g of the pan frame PF by the clip 21.

Then, the inclined portion 2g is inclined obliquely upward as it goes forward to follow the wire harness 3A disposed obliquely upward as it goes forward while passing below the front connection pipe 4B. For this reason, it is possible to prevent the wire harness 3A from being attached to the pan frame PF while being forcibly bent in the up to down direction. Then, since the bending of the wire harness 3A is prevented, it is possible to avoid the disconnection of the wire harness 3A. The lower end portion of the inclined portion 2g is more preferably located below the center axis of the front connection pipe 4B. With such a configuration, since it is possible to decrease a step between the lower end of the front connection pipe 4B and the lower end of the inclined portion 2g, it is possible to prevent the bending of the wire harness 3A when the wire harness 3A passing below the front connection pipe 4B is attached to the inclined portion 2g and thus to prevent the disconnection thereof.

As shown in FIG. 4, the wire harness 3B extends forward while passing above the front connection pipe 4B and below the side portion 2f of the pan frame PF at the end side of the cushion frame S1a in the seat width direction. Then, the wire harness 3B extends to the center side in the seat width direction while passing through a space formed by the concave portion 2ea at a position below the bent protrusion portion 2e. The wire harness 3B is supported by the clip 21 at the concave portion 2ea.

As described above, the side extension portion 2a is located above the front connection pipe 4B and the rear end of the side extension portion 2a is formed to extend to the rear side in relation to the front connection pipe 4B. For this reason, it is possible to limit the arrangement of the wire harness 3B at the upper position by the side extension portion 2a when the wire harness 3B is attached while passing between the front connection pipe 4B and the side extension portion 2a in the up to down direction along the side frame SF from both sides of the pan frame PF. Thus, it is possible to prevent the wire harness 3B from being bent upward.

Further, as described above, since the side portion 2f is formed at a position higher than the inclined portion 2g by the upright wall 2i, the wire harness 3B located at the upper side while passing above the front connection pipe 4B can pass below the pan frame PF. For this reason, since it is possible to dispose the wire harness 3A and the wire harness 3B at different positions in the up to down direction, it is possible to prevent both members from being entangled. Further, when the wire harness 3B passes through the concave portion 2ea, it is possible to dispose the wire harness 3B at the center side in the seat width direction while avoiding a contact between the wire harness 3B and the ECU 22 attached to the lower surface of the front portion 2d of the pan frame PF.

Furthermore, the clip 21 has been exemplified as one supporting the wire harnesses 3A and 3B, but the wire harnesses 3A and 3B may be supported while passing through holes formed in the cushion pad 1a.

TABLE OF REFERENCE NUMERALS

```
1a: cushion pad
1b: skin
2a: side extension portion (extension portion)
2b: front extension portion
2c: center portion
2d: front portion
2e: bent protrusion portion
    2ea: concave portion
2f: side portion
2g: inclined portion
2h: hemming portion
2i: upright wall
2j: attachment hole
3A, 3B: wire harness (linear member, member inside seat)
4A: rear connection pipe
4B: front connection pipe (connection member)
5: cushion member
6X, 6Y: wire
    6Xa, 6Ya: straight portion
    6Xb, 6Yb: S-shaped portion
7a: horizontal extension plate
7c: locking plate
11a, 11b: attachment member
20: connector
21: clip (attachment portion)
22: ECU
23: bead
24: side bead
    24a: outer extension portion
    24b: rear side extension portion
    24c: front side extension portion
    24d: inner extension portion
    24e: joint portion
25: fastener (connection portion)
PF: pan frame
S: vehicle seat (conveyance seat)
    S1: seat cushion
        S1a: cushion frame
    S2: seat back
        S2a: back frame
    Sa: seat frame
    SF: side frame
```

1. A conveyance seat comprising:
a cushion frame which includes right and left side frames respectively disposed at right and left sides of the cushion frame, a connection member that connects the right and left side frames, and a pan frame attached to respective front ends of the right and left side frames,
wherein the pan frame includes an inclined portion which is provided at a rear end side of a center side in a seat width direction and is inclined downward as it extends backward, and
wherein a lower end portion of the inclined portion is located below an upper end of the connection member.

2. The conveyance seat according to claim 1,
wherein the lower end portion of the inclined portion is located below a center axis of the connection member.

3. The conveyance seat according to claim 1,
wherein the inclined portion is provided with an attachment portion to which a linear member is attached.

4. The conveyance seat according to claim 1,
wherein the pan frame is provided with a concave portion having an inverse U-shaped cross-section that extends in a right to left direction.

5. The conveyance seat according to claim 4,
wherein a bead having an inverse U-shaped cross-section is formed along an edge of the concave portion.

6. The conveyance seat according to claim 1,
wherein an extension portion which extends in the front to back direction of the seat is formed at right and left sides of the pan frame, and
wherein the extension portion is located above the connection member and extends towards the rear side of the pan frame.

7. The conveyance seat according to claim 6,
wherein the extension portion is provided with a side bead, and
wherein the side bead extends toward a center of the extension portion from an outside of the seat width direction in relation to a connection portion between the side frame and the pan frame.

8. The conveyance seat according to claim 1,
wherein both ends of the inclined portion are connected to an outer portion of the pan frame in the seat width direction at an upright wall having a polygonal shape in side view.
